(19) United States
(12) Patent Application Publication
(10) Pub. No.: US 2026/0160330 A1
(43) Pub. Date: Jun. 11, 2026

(54) DYNAMIC TORQUE VISUALIZATION SYSTEM

(71) Applicant: Tesla,Inc., Austin, TX (US)

(72) Inventor: John Wesley Waldrop, Mountain View, CA (US)

(21) Appl. No.: 18/975,958

(22) Filed: Dec. 10, 2024

(51) Int. Cl. F16H 61/12; B60B 35/14; B60K 35/28; F16H 59/14; F16H 59/44; F16H 59/50; F16H 59/58; G07C 5/08

(52) U.S. Cl. CPC F16H 61/12; G07C 5/0808; G07C 5/0825; B60B 35/14; B60K 35/28; B60K 2360/167; B60K 2360/178; F16H 2059/147; F16H 59/44; F16H 59/50; F16H 59/58

(57) ABSTRACT

System and methods for managing and visualizing torque distribution in vehicles equipped with differential lockers and/or individual corner motors. According to certain examples, the system collects data from various sensors to determine torque values. A lookup table establishes safe torque thresholds based on driving conditions, particularly angles from articulation and steering. The system compares calculated or reported torque values against these thresholds to assess whether applied torque is within safe limits. Real-time visual feedback is dynamically displayed on an interior vehicle interface, showing both current torque application and maximum torque capacity for each wheel through intuitive bar elements. The system can issue alerts and impose torque limits automatically to prevent mechanical failures while enabling confident utilization of full vehicle capabilities.

### TECHNICAL FIELD

This invention pertains to the field of automotive technology, specifically to systems for managing and visualizing torque distribution in vehicles, including electric vehicles.

### BACKGROUND

The field of automotive technology has increasingly focused on enhancing the capabilities and safety of vehicles, including electric vehicles (EVs), particularly in challenging driving conditions such as off-roading. Modern EVs employ two primary approaches for torque distribution: differential lockers, which mechanically lock output shafts together to force wheels to turn in unison, and individual corner motors that supply torque directly to specific wheels. Both configurations aim to optimize traction and vehicle control across varying terrain conditions.

Existing technologies primarily utilize mechanical and software systems to manage torque distribution through either differential lockers or individual corner motors. These systems are designed to prevent damage to drivetrain components and improve vehicle handling. For instance, traditional systems might use basic sensors to monitor wheel speed and apply brake force to manage torque. However, these systems often lack the ability to provide real-time, detailed feedback to the driver regarding the actual torque applied to each wheel and the maximum torque capacity of each wheel.

One significant limitation of the prior art is the absence of a comprehensive system that integrates real-time torque monitoring with dynamic visual feedback. Current systems do not adequately address the need for drivers to understand and visualize the torque being applied in real-time, especially in scenarios where exceeding the torque capacity can lead to mechanical failures such as blown axles or Constant Velocity (CV) joints. Moreover, existing solutions do not dynamically adjust the visual feedback based on changes in vehicle conditions like steering angle and suspension height, which critically affect torque capacity.

### BRIEF SUMMARY

The present disclosure relates to the field of automotive technology, specifically focused on a system designed to manage and visually represent torque distribution in electric vehicles equipped with differential lockers and/or individual corner motors. Example systems seek to enhance the driving experience, particularly in off-roading scenarios, by providing real-time, dynamic feedback on torque application and capacity at each wheel.

Example systems seek to provide an advanced torque management system that not only effectively manages torque distribution but also provides intuitive, real-time visual feedback to the driver. Example systems dynamically adjust feedback based on varying driving conditions and offer predictive alerts to prevent damage, thereby seeking to enhance both the reliability and the off-roading capability of electric vehicles without adding significant cost or mass. Some examples aim to address conventional shortcomings by introducing a torque visualization and management system that leverages multiple sensor inputs to provide a comprehensive, real-time view of torque application and capacity across all wheels.

A feature of some examples is an ability to calculate and display a torque being applied to each wheel, as well as a maximum torque capacity of each wheel. In some examples with differential lockers, this is enabled through the integration of various sensors, including wheel speed sensors, ride height sensors, steering angle sensors, and torque estimator data. These sensors collectively feed data into a control system that calculates the wheel rotation delta and uses a lookup table to determine the threshold values for torque capacity based on the CV joint angles, which can be influenced by steering and suspension dynamics. In examples with individual corner motors, torque values are directly reported through their motor control systems.

Example systems dynamically adjust visual feedback based on changes in vehicle conditions such as steering angle and suspension height, which can affect torque capacity and distribution. The visual representation includes, in some examples, a torque capacity indicator that comprises a bar element for each wheel. In some examples, the bar element changes in length and color to reflect the current torque capacity and the torque being applied, seeking to providing a clear and intuitive display to help a driver of the vehicle make informed navigational decisions.

Some examples seek to provide drivers of vehicles with an intuitive and informative interface that not only prevents damage to the vehicle drivetrain components by alerting the driver when the applied torque approaches or exceeds safe limits but also enhances the vehicle's off-roading capabilities by allowing for safer and more informed driving decisions.

According to certain examples, the system includes features such as predictive alerts and active torque limiting, which may further enhance vehicle safety and performance. These features allow example systems not only to inform the driver of potential issues but also actively intervene to prevent mechanical damage by adjusting torque output. Example systems can issue alerts based on a comparison of the calculated torque values with the threshold values and can apply a torque limit to the drive unit associated with each halfshaft based on this comparison.

Examples seek to provide advantages over existing technologies by improving the safety, usability, and performance of vehicles equipped with differential lockers or individual corner motors. The ability of some example systems to provide real-time, accurate, and actionable torque distribution data in a user-friendly format may enhance the off-roading capabilities of vehicles, seeking to ensure both enhanced performance and increased reliability.

### BRIEF DESCRIPTION OF THE SEVERAL VIEWS OF THE DRAWINGS

Throughout the drawings, reference numbers may be re-used to indicate correspondence between referenced elements. The drawings are provided to illustrate examples of the subject matter described herein and not to limit the scope thereof.

FIG. 1 provides a depiction of a vehicle navigating uneven terrain, emphasizing wheel articulation, according to certain examples.

FIG. 2 provides a diagram showing aspects of a method of determining torque based on a wheel rotation delta, according to certain examples.

FIG. 3 illustrates a visualization to convey a torque capacity and utilization per wheel, according to certain examples.

FIG. 4 illustrates an interior display interface showing real-time graphical representations of torque capacity and utilization per wheel, according to certain examples.

FIG. 5 is a flow diagram illustrating example operations in a method for determining and presenting graphical representations of maximum torque per wheel, according to certain examples.

FIG. 6 is a system block diagram illustrating an architecture of an electric vehicle (EV), according to some examples.

### DETAILED DESCRIPTION

Described examples herein seek to provide a dynamic torque visualization system designed for vehicles equipped with differential lockers, seeking to enhance the driving experience in off-road conditions. According to certain examples, the system provides a real-time, accurate visualization of torque distribution across the vehicle's wheels, enabling drivers to optimize vehicle performance while seeking to minimize or prevent potential mechanical damage under varying driving conditions.

In some examples, such as in vehicles with differential lockers, torque values may be calculated based on wheel rotation delta measurements and halfshaft characteristics. In some examples, such as in vehicles with individual corner motors, the torque values may be directly reported through their motor control systems, enabling immediate torque measurement without the need for rotation-based calculations. For example, for some vehicles, such as vehicles with differential lockers, torque values may be calculated through rotation delta measurements and subsequent calculations. In some vehicles, such as vehicles with individual corner motors, the vehicles may provide direct torque reporting through their motor control systems, eliminating the need for rotation-based calculations.

Accordingly, the system receives sensor data from a variety of devices installed on a vehicle, including wheel speed sensors, torque sensors, ride height sensors, and steering angle sensors. Following data collection, the system calculates the wheel rotation delta between the first and second wheels of an axle. In some examples, the axle includes a differential that distributes torque via halfshafts connected to each wheel. A wheel rotation delta indicates differences in rotational movement between paired wheels.

In some examples, systems determine a total torque value of each halfshaft based on rotation measurements. In some examples, such as vehicles that include differential lockers, this is calculated from the wheel rotation delta and a predefined stiffness value that describes resistance to torsional deformation under load (i.e., of a halfshaft). To ensure the torque applied is within safe limits, example systems access a lookup table containing threshold values for various driving conditions, for example angles created by articulation and steering. In some examples, a lookup table may facilitate determination of acceptable torque limits based on the current driving conditions.

According to certain examples, a comparison is performed between the total torque value and the threshold value derived from the lookup table. In some examples, the total torque value includes both the baseline (or “trapped” torque) calculated from rotation measurements and the drive unit torque divided by two. This comparison provides an assessment of whether the torque being applied is within safe operational limits, or if limits or alerts are needed to avoid mechanical stress or failure. In some examples, the system displays a visual representation of this comparison on the vehicle's dashboard or a dedicated display system. This visual representation, which may include graphical elements like bars, dials, or digital readouts, provides the driver with readily available visual feedback on the torque status of the halfshafts, indicating how close the current torque is to the threshold limit.

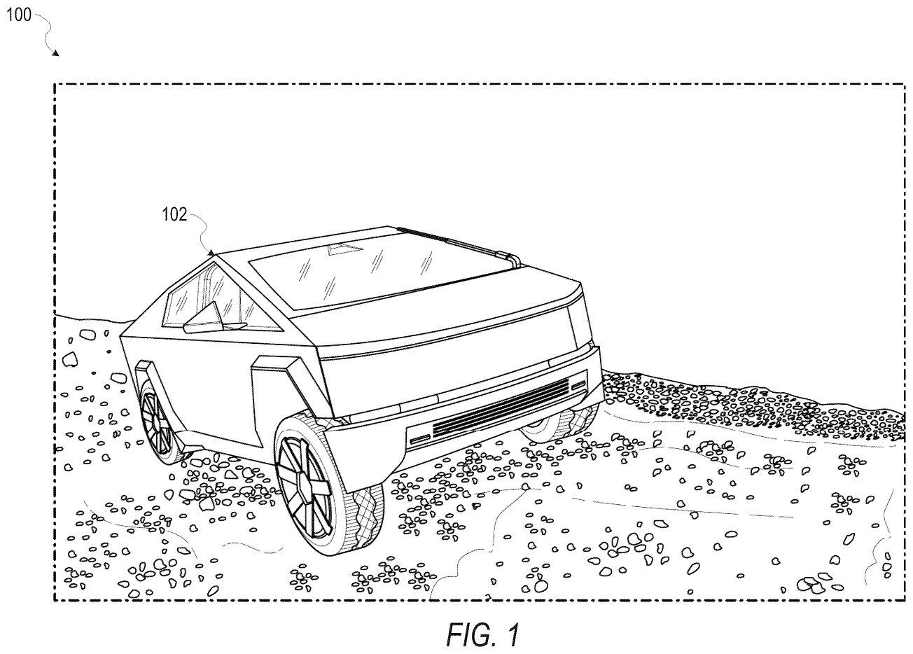

FIG. 1 provides a depiction 100 of a vehicle 102 navigating uneven terrain, emphasizing wheel articulation, according to certain examples.

As seen in the depiction 100, the vehicle 102 is shown traversing rugged terrain that includes obstacles such as rocks and uneven surfaces, causing significant wheel articulation.

Wheel articulation involves the vertical movement of the wheels relative to the vehicle, which is common in off-road conditions. When a wheel encounters an obstacle, the suspension must extend or compress significantly to adapt to the change in surface level. This dynamic movement can lead to extreme angles and stress on the drivetrain components, for example like halfshafts and CV joints. These components, which transmit torque from the drive unit to the wheels, are subjected to torsional and bending stresses that increase with the degree of articulation.

The CV joints and their housing are particularly vulnerable components in the drivetrain. These joints must accommodate the changing angles while maintaining smooth rotational speeds. Under normal conditions, CV joints operate within their design limits. However, excessive articulation caused by off-road terrain can push these joints beyond their operational thresholds, leading to potential failures. For instance, the increased angle can cause the internal components of the CV joint and housing to bind or wear unevenly, ultimately leading to joint failure.

The failure of a CV joint or a halfshaft during high articulation scenarios typically manifests as a loss of torque transmission to the wheel, leading to vehicle immobilization or, at minimum, reduced traction and stability. Such failures not only pose risks to vehicle safety but also increase maintenance costs and downtime.

To mitigate these risks, a dynamic torque visualization system monitors the torque applied to each wheel while comparing it to predefined safe operational thresholds stored in a lookup table. The system can predict and prevent conditions that might lead to mechanical overloads and subsequent failures. The system adjusts the torque distribution dynamically, reducing the load on overstressed components when excessive articulation is detected.

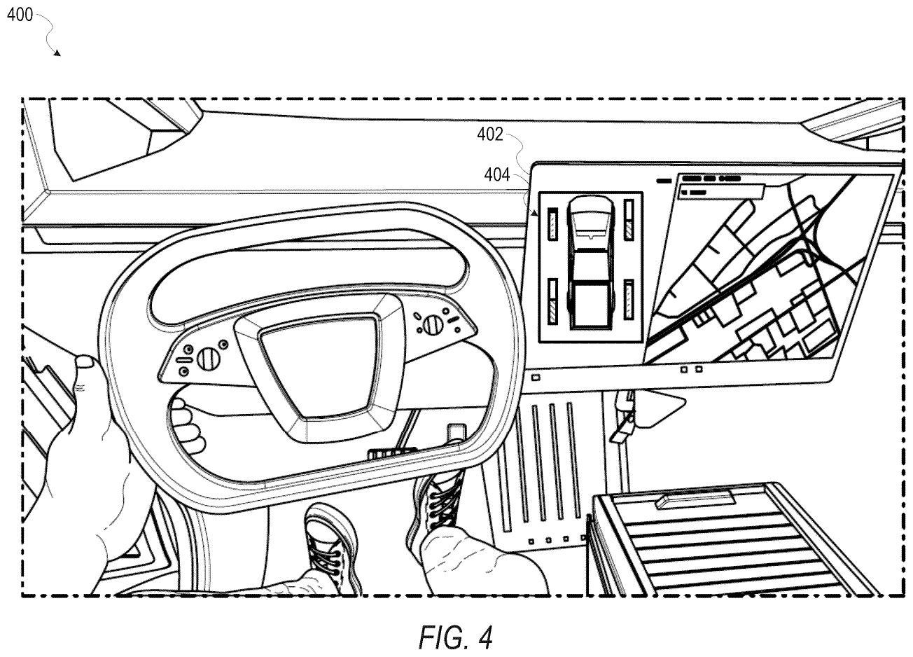

According to certain examples, the system may visually represent these dynamics on a display (as depicted in FIG. 4) to allow the driver to be aware of the current mechanical stresses in real-time. This awareness enables proactive driving adjustments to avoid terrain interactions that might push the suspension components beyond their safe operational limits, while also providing drivers with the information needed to confidently utilize the full capability of their vehicles within those limits.

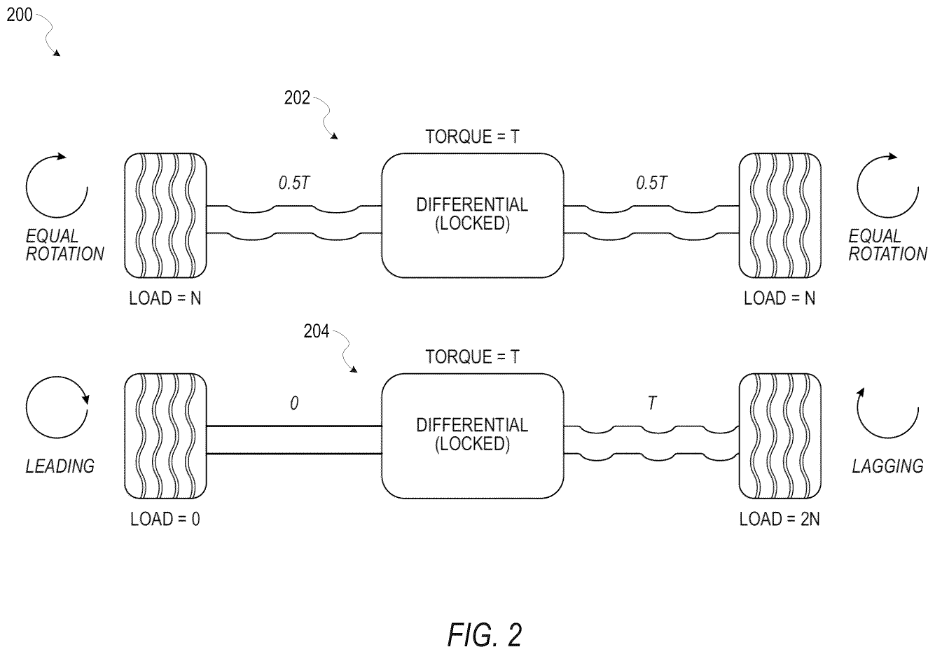

FIG. 2 provides a diagram showing aspects of a method of determining torque based on a wheel rotation delta, according to certain examples. The diagram 200 comprises a scenario 202 and a scenario 204, to illustrate how different wheel rotation deltas may influence torque distribution and load handling.

Scenario 202 depicts a scenario where there is no delta between the left and right wheels, indicating synchronized wheel rotation.

In scenario 202, wheel speed sensors actively monitor the rotation of the left and right wheels. According to certain examples, the wheel speed sensors may collect data through one or more methods. In some examples, the method may include receiving direct pulse counting from the sensors. In some examples, the method utilizes sensors that process pulses internally and report speed measurements, which are then integrated over time to measure rotation. In some examples, error accumulation may occur during operation.

Accordingly, in some examples, the system may implement certain error correction methods that activate under specific conditions. For example, when driving on flat ground, as indicated by wheel articulation sensors, the left-hand to right-hand rotation delta should approximate zero. Additionally, when wheel articulation indicates a wheel is suspended in air, the rotation delta calculations assume all torque transfers through the grounded wheel. These correction mechanisms apply specifically to differential locker configurations, as individual motors report torque directly.

As an illustrative example, with the differential locker engaged, the wheel rotation delta is initially set to zero. In this scenario, each wheel receives an equal share of torque, specifically (0.5T) from the total torque (T). The system's primary error correction method involves confirming the accuracy of the rotation delta through CAN bus signals. When inaccuracies are detected, the system implements correction mechanisms to maintain accuracy. Under normal operation with accurate rotation delta measurements, each wheel supports a load value of (N), reflecting balanced and stable driving conditions under equal wheel rotation.

Scenario 204 illustrates a condition where one wheel (i.e., the left wheel) leads and the other wheel lags (i.e., the right wheel), demonstrating an unequal wheel rotation. Scenario 204 may be detected by the wheel speed sensors, where the left wheel (LH) emits more positive pulses compared to the right wheel (RH), indicating it has rotated further. This results in a positive wheel rotation delta.

Due to the lagging of the right wheel, which encounters more resistance, the differential redirects a greater amount of torque to the right wheel, now bearing a load of (2N). Conversely, the left wheel, experiencing reduced traction or contact, shows a load of (0) and a torque value of (0).

According to certain examples, the wheel rotation delta, in conjunction with the halfshaft stiffness, is utilized to calculate a baseline or “trapped” torque in each halfshaft. In scenario 204, the side that rotates more (left) exhibits a negative baseline torque, while the opposite side (right) displays an equal magnitude but positive baseline torque. The drive unit (DU) torque divided by 2 is then added to each halfshaft to determine the total applied torque. This total torque value may serve as both an input for the visual representation system and for comparison against component strength thresholds. In some examples, the strength thresholds are determined from a lookup table or formula that incorporates the baseline strength and the angles of the CV joints influenced by the steered angle and corner ride height.

Once the differential locker is disengaged, the wheel rotation delta is reset to zero and remains at zero until the locker is re-engaged, ensuring that the system starts with a neutral baseline for subsequent engagements.

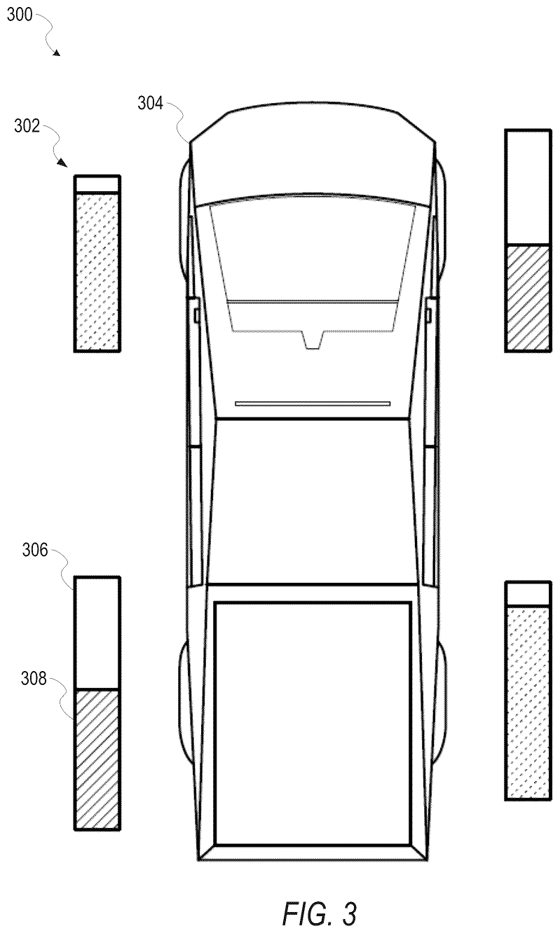

FIG. 3 illustrates a visualization 300 to convey a torque capacity and utilization per wheel, according to certain examples. The visualization 300 may provide dynamic feedback mechanisms to enhance driver awareness and vehicle safety. Accordingly, the visualization 300 may be particularly useful in scenarios involving challenging driving conditions where precise torque management may be helpful to prevent mechanical failures and optimize performance.

According to certain examples, the visualization 300 may be displayed on a vehicle interface, as depicted in FIG. 4, showing a representation of a vehicle 304. Positioned proximate to each corresponding wheel on the representation of the vehicle 304, the bar elements 302 serve as the primary visual tool for conveying torque information. Each bar element includes an overall length attribute (i.e., length 306), which represents the maximum torque capacity for each wheel. The length 306 of these bar elements 302 is dynamically adjusted based on various factors that may include halfshaft/CV characteristics, such as halfshaft strength (e.g., from the lookup table), and CV joint angles, as derived from the vehicle sensor data and calculated as described herein.

Within each bar element 302, a central bar element 308, dynamically adjusts its length to represent the amount of torque currently being applied to each wheel. The length of the central bar increases or decreases in real-time, reflecting changes in driving conditions and torque application. This feature allows the driver to visually assess how close the applied torque is to the maximum safe torque limit, enabling confident utilization of the vehicle's full capabilities while maintaining safe operation.

According to certain examples, the bar elements may employ color changes to provide additional visual feedback about torque utilization. As the central bar element approaches the maximum torque capacity, its color may transition to indicate proximity to operational limits. This color-based indication works in conjunction with the bar length to provide multiple visual cues about torque status. For example, the color may shift as torque increases to warn the driver when approaching capacity thresholds, while maintaining the length-based representation of actual torque values.

The dynamic nature of visualization 300 is designed to provide real-time feedback to the driver, enhancing the ability to make informed decisions regarding vehicle handling and torque application. As the vehicle navigates different terrains and encounters various driving conditions, the bar elements adjust in real-time to reflect the current torque dynamics. The visualization 300 helps in preventing the application of excessive torque that could lead to mechanical failures such as blown CV joints or damaged halfshafts. By visually indicating how much of the available torque capacity is being used, drivers can adjust their driving strategy to stay within safe operational limits. For vehicles equipped with differential lockers, such as in off-roading scenarios, the visualization 300 allows drivers to understand the impact of locker engagement on torque distribution and make adjustments to optimize traction and vehicle stability.

FIG. 4 illustrates diagram 400 depicting an interior display interface 402, which shows a real-time graphical representation 404 of a current maximum torque per wheel (i.e., the visualization 303), according to certain examples. As discussed above, the graphical representation 404 is designed to enhance driver awareness and vehicle safety by dynamically displaying torque distribution across the wheels of the vehicle.

According to certain examples, a vehicle may include an interior display interface 402 that features a high-resolution display screen. The display interface 402 is a digital display embedded within the vehicle's interior, to present critical driving information in a clear and accessible manner. The dynamic torque visualization system may display the visualization 404 upon the display interface 402 responsive to inputs received via the display interface 402. For example, a driver of the vehicle may choose to access the visualization 404 based on explicit inputs to retrieve and display the visualization 404, or in some embodiments, the visualization 404 may be displayed when the vehicle is determined to be navigating uneven terrain.

According to certain examples, the visualization 404 includes several key elements that provide a comprehensive overview of torque dynamics. It features bar elements corresponding to each wheel of the vehicle, visually indicating the maximum torque capacity and the current torque being applied. Each bar element is designed to change in real-time, reflecting the dynamic conditions of vehicle operation. The overall length attribute of these bar elements represents the maximum torque, or torque capacity, that can be safely applied to each wheel, adjusting dynamically based on various factors including halfshaft strength (e.g., from the lookup table), and CV joint angles. Within each bar element, a central bar dynamically adjusts to show the actual torque being applied at any given moment, providing a visual cue to the driver about how close the applied torque is to the maximum safe limit, enabling proactive adjustments to driving inputs, enabling confident utilization of the vehicle's full capabilities while maintaining safe operation.

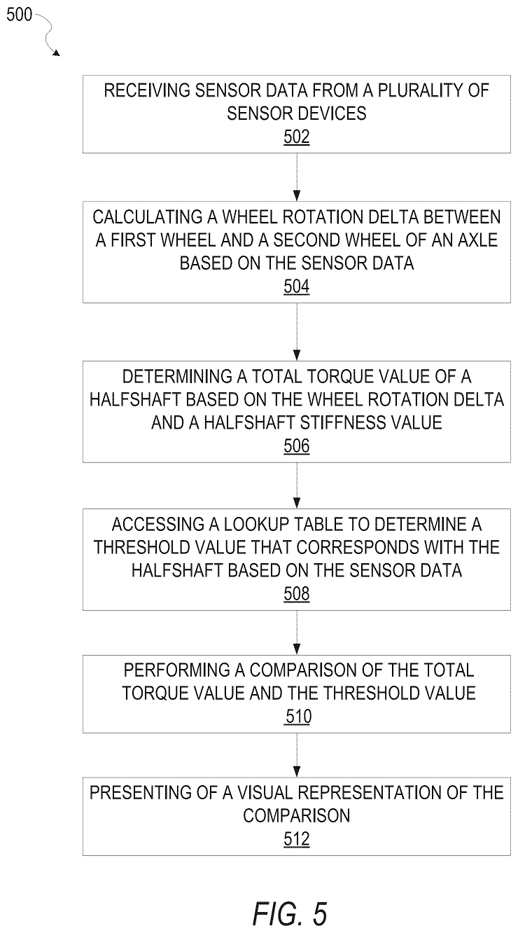

FIG. 5 is a flow diagram illustrating a method 500 for presenting graphical representations of maximum torque per wheel, according to certain examples.

At operation 502, sensor data is collected from a plurality of sensor devices installed on the vehicle. These sensors may include wheel speed sensors, torque estimation sensors, ride height sensors, and steering angle sensors, providing a comprehensive dataset that reflects the dynamic parameters affecting the vehicle's drivetrain.

Following data collection, at operation 504, in certain examples the system calculates a wheel rotation delta between a first wheel and a second wheel of an axle. This calculation determines the difference in rotational movement between the two wheels, which is critical for assessing the differential torque being applied across the axle.

At operation 506, a baseline torque value of a halfshaft is determined based on the wheel rotation delta calculated previously and the halfshaft stiffness value, which describes the resistance of the halfshaft to torsional deformation under load. According to certain examples, the baseline torque value calculation also incorporates torque estimation data, which provides information about the drive unit's torque output. For example, this calculation may include using the wheel rotation delta and halfshaft stiffnesses in series to determine a baseline or “trapped” torque in each halfshaft (negative on the side that has rotated more, equal magnitude but positive on the other), then adding the drive unit torque divided by two to each side. The baseline torque value, combined with the drive unit torque divided by two, represents the effective torque being applied through the halfshaft, accounting for the mechanical twist in the system, wherein the mechanical twist may refer to the torsional deformation that occurs in halfshafts under load conditions, which is measured through the wheel rotation delta between paired wheels.

At operation 508, the system accesses a lookup table to determine a threshold value that corresponds with the halfshaft based on the sensor data. According to certain examples, the lookup table contains pre-determined threshold values that correlate with various operational conditions and halfshaft characteristics, providing a benchmark for safe torque application.

At operation 510, the system performs a comparison of the baseline torque value determined in operation 506 with the threshold value obtained from the lookup table in operation 508. This comparison provides an assessment of whether the torque applied is within safe operational limits or if adjustments are needed to prevent potential mechanical stress or failure.

Finally, at operation 512, the system presents the display of a visual representation of the comparison made in operation 510. This visual representation may be presented on an interior display interface within the vehicle, allowing the driver to see in real-time how the actual torque applied compares to the maximum safe torque. In some examples, the system may issue alerts, including visual or auditory alerts to warn the driver when torque values approach or exceed certain thresholds.

For example, the auditory alerts may complement the visual display by providing immediate feedback without requiring the driver to look at the display interface, which is particularly valuable in challenging off-road conditions where the driver's visual attention needs to remain focused on the terrain. The system can be configured to provide different audio tones or verbal warnings based on the severity of the torque threshold breach, offering escalating levels of urgency in the auditory feedback as the applied torque approaches critical limits.

In some examples, the system seeks to further enhance vehicle safety and performance by imposing a maximum torque limit to one or more of the wheels based on the outcomes of the comparison. This proactive feature is designed to prevent the application of excessive torque that could potentially lead to mechanical failures or loss of vehicle control, especially under challenging driving conditions.

For example, when the calculated torque approaches or exceeds the threshold values determined in operation 508, the system can automatically adjust the torque output to the affected wheels, ensuring that it does not surpass the maximum safe limits. This adjustment is executed through the vehicle drive control systems, which modulate the power output to the wheels in response to the real-time data analysis provided by the system. The imposition of torque limits may be particularly critical in scenarios such as off-roading, where the risk of wheel slippage or drivetrain damage is higher due to uneven terrains and varying traction conditions.

Accordingly, in some examples, the visual representation on the display interface not only shows the current torque but also dynamically updates to reflect any adjustments made by the system in imposing these torque limits. This feature provides the driver with immediate feedback about the adjustments being made to the vehicle's torque output, enhancing the driver's awareness and ability to respond to the driving conditions. Additionally, this system can be configured to provide alerts or warnings to the driver when critical torque thresholds are approached or exceeded, further aiding in the decision-making process and enhancing overall vehicle safety.

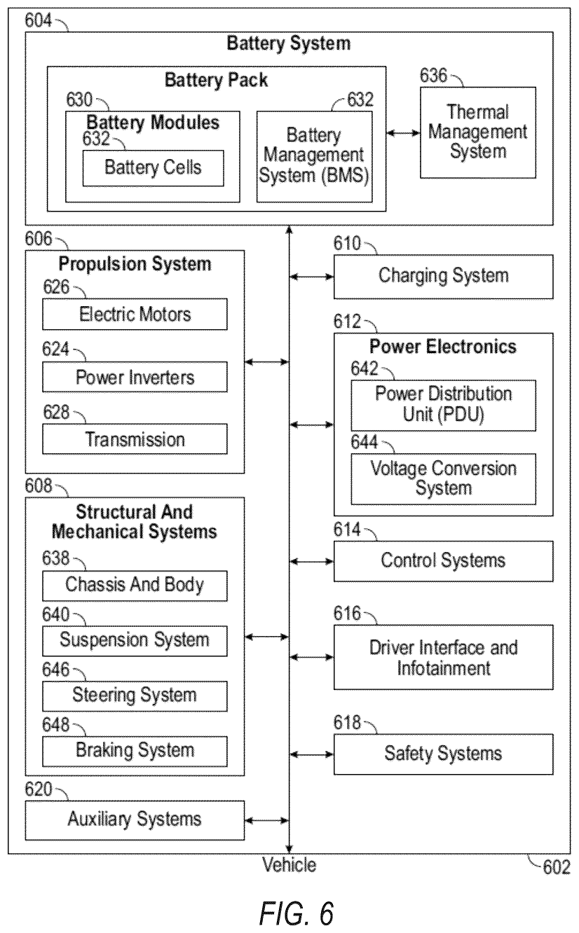

FIG. 6 is a block diagram of an example system illustrating an architecture of an electric vehicle (EV) 602, according to some examples. This diagram shows systems and sub-systems that collectively enable the functionality and operational efficiency of the electric vehicle 10.

The vehicle 602 includes a number of higher-level systems which are interconnected, including a battery system 604, a propulsion system 606, structural and mechanical systems 608, a charging system 610, power electronics 612, control systems 614, driver interface and infotainment 616, safety systems 618, and auxiliary systems 620.

The propulsion system 606 includes one or more electric motors 13, which may include traction motors for propulsion and motors for regenerative braking systems, convert electrical energy into mechanical energy. Power inverters 624, facilitate the conversion of DC power from the battery to AC power required by the electric motors 626. The propulsion system also includes a transmission 628, which may consist of a single-speed transmission or gearbox, channeling mechanical power to the vehicle's wheels.

The battery system 604 is composed of several battery modules 630, each housing multiple battery cells 632. These battery cells 632 may be based on various chemistries, including lithium-ion, lithium-polymer, or solid-state materials, each offering distinct features and/or abilities in terms of energy density, recharge cycles, and safety profiles.

A battery management system (BMS) 634 continuously monitors various parameters, such as voltage, current, and temperature of each of the battery cells 632 and battery modules 630, to prevent conditions that could lead to overcharging, deep discharging, or thermal runaway. The battery management system (BMS) 634 also manages the state of charge (SoC) and state of health (SoH) of the battery, ensuring that the energy is distributed during discharge and that the charging process is optimized for longevity and safety. Each battery management system (BMS) 634 employs algorithms to balance the charge across the cells and modules, correcting imbalances that can reduce the battery's overall capacity and lifespan.

Integrated with the battery system 604 is a thermal management system 636, which operatively maintains the battery cells 632 within specified temperature ranges. The thermal management system 636 employs temperature sensors to monitor the heat generated by the battery cells 632 during operation. Based on the data collected, it activates cooling and heating mechanisms to regulate the battery's temperature. Cooling methods can include air cooling, where ambient air is circulated around the battery modules, or liquid cooling, where a coolant is circulated through channels in or around the battery modules to absorb and dissipate heat. In colder environments, the thermal management system 636 may employ heating elements or use waste heat from the vehicle's systems to warm the battery cells, ensuring they operate efficiently even in low temperatures.

The charging system 610 operatively replenishes the stored energy within the battery system 604 of the electric vehicle 602. It supports various charging methodologies to ensure flexibility and convenience in energy restoration. The charging system 610 may encompass systems for both standard (Level 1 and Level 2) and fast charging (DC fast charging), facilitating a range of charging speeds to suit different user needs and infrastructure capabilities.

For standard charging, the charging system 610 includes an onboard charger for AC/DC conversion. This onboard charger converts the alternating current (AC) from the electrical grid or home outlets into direct current (DC) that can be stored in the vehicle's battery system 604. The onboard charger may, for example support Level 1 and Level 2 charging, with Level 1 charging using standard household outlets (608-120V) and Level 2 charging requiring a higher voltage source (208-240V), such as those found in dedicated charging stations or installed in residential garages.

For fast charging, the charging system 610 may incorporate a DC fast charging system, designed for rapid energy transfer directly to the vehicle's battery system 604, bypassing the onboard charger. DC fast charging stations supply high-voltage (e.g., 400V to 800V) direct current directly to the battery system 604.

Additionally, the electric vehicle 602 may be equipped with an auxiliary battery, such as a 12V lead-acid or lithium-ion battery may be tasked with powering the vehicle's low-voltage systems, including lighting, infotainment, electronic control units, and other ancillary components, ensuring their operation even when the main battery system is off or during the initial stages of charging when the main system's voltage might be too low for these tasks. This separation of power sources enhances the vehicle's electrical system reliability and ensures the availability of potentially essential functions.

Structural and mechanical systems 608, including a chassis and body 638 and suspension system 640, provide the physical framework and support for the vehicle 602. The chassis and body 638 constitute the vehicle's primary structure, while the suspension system 640, which may include springs, shock absorbers (or dampers), and control arms, to provide a smooth and stable ride by mitigating road shocks and vibrations.

Power electronics 612, including a power distribution unit (PDU) 642 and a voltage conversion system 644, are responsible for the management and conversion of electrical power within the vehicle. The power distribution unit (PDU) 642, equipped with fuses and relays, distributes power to various vehicle systems, while voltage conversion devices of the voltage conversion system 644, such as DC/DC and AC/DC converters, adjust the voltage levels to meet the specific requirements of different components.

Control systems 614 facilitate the driver's command over the vehicle, with a steering system 646 and a braking system 648 as examples. The steering system 646, including a power steering motor, allows for precise directional control, whereas the braking system 648, which may feature disc brakes and an anti-lock braking system (ABS), enables deceleration and stopping.

The driver interface and infotainment 616 supports the driving experience by providing vehicle information and entertainment options through digital displays and multimedia systems. Connectivity features, such as Bluetooth and USB, further augment functionality.

Safety systems 618, designed to protect the vehicle's occupants, may include airbag systems and advanced driver-assistance systems (ADAS), for example. ADAS may use an array of sensors, cameras, radar, LiDAR, and/or ultrasonic devices to monitor the vehicle's surroundings, detect potential hazards, and execute or suggest corrective actions to prevent accidents and mitigate their impact.

ADAS can be categorized into different levels of self-driving capabilities, ranging from Level 0, where the human driver performs all driving tasks, to Level 5, which represents full automation with no human intervention required under any circumstances. Levels 1 and 2 focus on driver assistance and partial automation, respectively, where systems such as adaptive cruise control, lane-keeping assistance, and automatic emergency braking support the driver but do not replace them. Level 3, conditional automation, allows the vehicle to handle all aspects of driving in certain conditions, but requires the driver to be ready to take control when needed. Level 4, high automation, enables the vehicle to operate independently in most scenarios, though human override is still possible.

Examples of ADAS that contribute to these levels of automation include, but are not limited to, adaptive cruise control, which adjusts the vehicle's speed to maintain a safe distance from vehicles ahead; lane departure warning systems, which alert the driver when the vehicle begins to drift out of its lane; and automatic parking systems, which assist or take over control of the vehicle during parking maneuvers. More advanced systems, contributing to higher levels of automation, involve complex algorithms and machine learning capabilities to interpret sensor data, predict actions of other road users, and make real-time driving decisions.

Auxiliary systems 620 support the vehicle's functions and occupant comfort, with climate control and lighting systems as examples. The auxiliary systems 620 may also include windshield wipers etc.

As noted above, the systems of the 602 are communicatively connected. Communications between the interconnected systems within vehicle 602 are facilitated through a vehicle network architecture, employing both hardware and software components to ensure seamless data exchange and coordination. This network architecture may include one or more vehicle communication buses, such as for example Controller Area Network (CAN), Local Interconnect Network (LIN), FlexRay, and Ethernet, which serve as the backbone for intra-vehicle communications.

The Controller Area Network (CAN) bus is a vehicle bus standard designed to allow microcontrollers and devices to communicate with each other within the vehicle 602 without a host computer. Such a network may support control communications between systems such as the battery system 604, propulsion system 606, and control systems 614, due to its high reliability and resistance to interference. A CAN bus may support messages that ensure real-time control and monitoring of these systems.

For other communications, such as those involving the driver interface and infotainment 616 or auxiliary systems 620, a Local Interconnect Network (LIN) bus may be employed. LIN may provide a cost-effective, low-speed serial communication system for connecting intelligent sensors and actuaries. It may serve as a sub-network to the CAN bus, handling signals such as switch inputs and actuator outputs.

FlexRay technology offers a higher data rate compared to CAN and LIN, providing the necessary bandwidth for advanced control systems, including those required for autonomous driving functionalities within safety systems 618. Its deterministic nature and fault tolerance make it suitable for applications that require precise timing and synchronization, such as coordinating the actions of multiple control units in real-time.

Ethernet, with its high data transfer rate, may for example be adopted for diagnostics and infotainment applications within the vehicle 602. It supports the rapid transfer of large volumes of data, making it well suited for advanced driver assistance systems (ADAS), software updates, and multimedia streaming in the driver interface and infotainment 616 system.

Software protocols and application programming interfaces (APIs) built on top of these physical layers enable high-level communication and data exchange between systems. These protocols may define the rules for data format, timing, and error handling, ensuring that messages are correctly interpreted and acted upon by the receiving systems.

### EXAMPLES

Thus, some embodiments may include one or more of the following examples.

Example 1 is a method comprising the steps of receiving sensor data from a plurality of sensor devices, calculating a wheel rotation delta between a first wheel and a second wheel of an axle, determining a total torque value of at least the first halfshaft based on the wheel rotation delta, accessing a lookup table to determine a threshold value that corresponds with the first halfshaft based on the sensor data, performing a comparison of the total torque value of the first halfshaft with the threshold value, and causing display of a visual representation of the comparison.

Example 2 includes the subject matter of Example 1, with the additional feature of determining the total torque value based on the wheel rotation delta and a halfshaft stiffness value associated with the first halfshaft.

Example 3 includes the subject matter of any one of Example 1 or Example 2, with the additional feature of issuing an alert based on the comparison.

Example 4 includes the subject matter of any one of Examples 1-3, with the additional feature of applying a torque limit to a drive unit associated with the first halfshaft based on the comparison of the first total torque value with the threshold value.

Example 5 includes the subject matter of any one of Examples 1-4, wherein the sensor data includes one or more of the list comprising wheel speed data, ride height sensor data, steering angle sensor data, and torque estimator data that indicate a torque output of a drive unit.

Example 6 includes the subject matter of any one of Examples 1-5, wherein accessing the lookup table to determine the threshold value includes determining a Constant Velocity (CV) joint angle associated with a CV joint of the first halfshaft based on the sensor data, and wherein the lookup table correlates the CV joint angle with the threshold.

Example 7 includes the subject matter of any one of Examples 1-6, wherein the visual representation of the comparison includes a torque capacity indicator that comprises a bar element, wherein the bar element comprises a first graphical attribute based on the threshold value and a second graphical attribute based on the first total torque value.

Example 8 includes the subject matter of any one of Examples 1-7, wherein the visual representation of the comparison includes a graphical representation of a vehicle that comprises an indication of the comparison of the first total torque value of the first halfshaft with the threshold value at a position upon the graphical representation of the vehicle that corresponds with the first wheel.

Example 9 is a system comprising an axle, one or more sensor devices, a memory, and one or more processors configured to perform operations similar to those described in Example 1.

Example 10 includes the subject matter of Example 9, with the additional feature of determining the total torque value based on the wheel rotation delta and a halfshaft stiffness value associated with the first halfshaft.

Example 11 includes the subject matter of any one of Example 9 or Example 10, further comprising issuing an alert based on the comparison.

Example 12 includes the subject matter of any one of Examples 9-11, further comprising applying a torque limit to a drive unit associated with the first halfshaft based on the comparison of the first total torque value with the threshold value.

Example 13 includes the subject matter of any one of Examples 9-12, wherein the sensor data includes one or more of the list comprising wheel speed data, ride height sensor data, steering angle sensor data, and torque estimator data that indicate a torque output of a drive unit.

Example 14 includes the subject matter of any one of Examples 9-13, wherein accessing the lookup table to determine the threshold value includes determining a Constant Velocity (CV) joint angle associated with a CV joint of the first halfshaft based on the sensor data, and wherein the lookup table correlates the CV joint angle with the threshold.

Example 15 includes the subject matter of any one of Examples 9-14, wherein the visual representation of the comparison includes a torque capacity indicator that comprises a bar element, wherein the bar element comprises a first graphical attribute based on the threshold value and a second graphical attribute based on the first total torque value.

Example 16 includes the subject matter of any one of Examples 9-15, wherein the visual representation of the comparison includes a graphical representation of a vehicle that comprises an indication of the comparison of the first total torque value of the first halfshaft with the threshold value at a position upon the graphical representation of the vehicle that corresponds with the first wheel.

Example 17 is a non-transitory machine-readable storage medium, comprising instructions that when executed by one or more processors of a machine, cause the machine to perform operations comprising the steps described in Example 1.

Example 18 is a non-transitory machine-readable storage medium of Example 17, with the additional feature of determining the total torque value based on the wheel rotation delta and a halfshaft stiffness value associated with the first halfshaft.

Example 19 includes the subject matter of any one of Example 17 or Example 18, further comprising issuing an alert based on the comparison.

Example 20 includes the subject matter of any one of Examples 17-19, further comprising applying a torque limit to a drive unit associated with the first halfshaft based on the comparison of the first total torque value with the threshold value.

It should be noted that the description and the figures above merely illustrate the principles of the present subject matter along with examples described herein and should not be construed as a limitation to the present subject matter. It is thus understood that various arrangements may be devised that although not explicitly described or shown herein, embody the principles of the present subject matter. Moreover, all statements herein reciting principles, aspects, and implementations of the present subject matter, as well as specific examples thereof, are intended to encompass equivalents thereof.

It is to be understood that not necessarily all objects or advantages may be achieved in accordance with any particular example described herein. Thus, for example, those skilled in the art will recognize that some examples may be operated in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the example, some acts, events, or functions of any of the algorithms described herein can be performed in a different sequence, can be added, merged, or left out altogether (for example, not all described acts or events are necessary for the practice of the algorithms). Moreover, in some examples, acts or events can be performed concurrently, for example, through multi-threaded processing, interrupt processing, or multiple processors or processor cores, or on other parallel architectures, rather than sequentially. In addition, different tasks or processes can be performed by different machines and/or computing systems that can function together.

The various illustrative logical blocks and modules described in connection with the examples disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combination of the same, or the like. A processor can include electrical circuitry to process computer-executable instructions. In some examples, a processor includes an FPGA or other programmable device that performs logic operations without processing computer-executable instructions. A processor can also be implemented as a combination of computing devices, for example, a combination of a DSP and a microprocessor, a plurality of microprocessors, microprocessors in conjunction with a DSP core, or any other such configuration.

Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few. The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

The processes described herein or illustrated in the figures of the present disclosure may begin in response to an event, such as on a predetermined or dynamically determined schedule, on demand when initiated by a user or system administrator, or in response to some other event. When such processes are initiated, a set of executable program instructions stored on one or more non-transitory computer-readable media (e.g., hard drive, flash memory, removable media, etc.) may be loaded into memory (e.g., RAM) of a server or other computing device. The executable instructions may then be executed by a hardware-based computer processor of the computing device. In some embodiments, such processes or portions thereof may be implemented on multiple computing devices and/or multiple processors, serially or in parallel.

Although the described flow diagrams herein can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

Conditional language such as, among others, “can,” “could,” “might” or “may,” unless specifically stated otherwise, are otherwise understood within the context as used in general to convey that some examples include, while other examples do not include, some features, elements and/or steps. Thus, such conditional language is not generally intended to imply that features, elements and/or steps are in any way for examples or that examples necessarily include logic for deciding, with or without user input or prompting, whether these features, elements and/or steps are included or are to be performed in any particular example.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that some examples require at least one of X, at least one of Y, or at least one of Z to each be present.

Any process descriptions, elements or blocks in the flow diagrams described herein and/or depicted in the attached figures should be understood as potentially representing modules, segments, or portions of code which include executable instructions for implementing specific logical functions or elements in the process. Alternate examples are included within the scope of the examples described herein in which elements or functions may be deleted, executed out of order from that shown, or discussed, including substantially concurrently or in reverse order, depending on the functionality involved as would be understood by those skilled in the art.

It should be emphasized that many variations and modifications may be made to the above-described examples, the elements of which are to be understood as being among other acceptable examples. All such modifications and variations are intended to be included herein within the scope of this disclosure.

Any process descriptions, elements or blocks in the flow diagrams described herein and/or depicted in the attached figures should be understood as potentially representing modules, segments, or portions of code which include executable instructions for implementing specific logical functions or elements in the process. Alternate implementations are included within the scope of the examples described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

It will also be appreciated that one or more of the elements depicted in the drawings/figures can also be implemented in a more separated or integrated manner, or even removed or rendered as inoperable in certain cases, as is useful in accordance with a particular application.

What is claimed is:

1. A method of visualizing torque distribution in a vehicle, the method comprising:
receiving sensor data from a plurality of sensor devices mounted to the vehicle;
calculating a wheel rotation delta between a first wheel and a second wheel on an axle based on the sensor data, the axle comprising a differential, a first halfshaft that connects the first wheel to the differential, and a second halfshaft that connects the second wheel to the differential;
determining a total torque value of at least the first halfshaft based on the wheel rotation delta;
accessing a lookup table to determine a threshold value that corresponds with the first halfshaft based on the sensor data, the lookup table correlating the threshold value with the sensor data;
performing a comparison of the total torque value of the first halfshaft with the threshold value; and
causing display of a visual representation of the comparison.

2. The method of claim 1, wherein the determining the total torque value is based on the wheel rotation delta and a halfshaft stiffness value associated with the first halfshaft.

3. The method of claim 1, further comprising:
issuing an alert based on the comparison.

4. The method of claim 1, further comprising:
applying a torque limit to a drive unit associated with the first halfshaft based on the comparison of the total torque value with the threshold value.

5. The method of claim 1, wherein the sensor data includes one or more data elements of a list of data elements comprising:
wheel speed data;
ride height sensor data;
steering angle sensor data; and
torque estimator data that indicate a torque output of a drive unit.

6. The method of claim 1, wherein the accessing the lookup table to determine the threshold value includes:
determining a Constant Velocity (CV) joint angle associated with a CV joint of the first halfshaft based on the sensor data; and
wherein the lookup table correlates the CV joint angle with the threshold value.

7. The method of claim 1, wherein the visual representation of the comparison includes a torque capacity indicator that comprises a bar element, wherein the bar element comprises a first graphical attribute based on the threshold value and a second graphical attribute based on the total torque value.

8. The method of claim 1, wherein the visual representation of the comparison includes a graphical representation of a vehicle that comprises an indication of the comparison of the total torque value of the first halfshaft with the threshold value at a position upon the graphical representation of the vehicle that corresponds with the first wheel.

9. A system for visualizing torque distribution in a vehicle comprising:
an axle comprising a differential, a first wheel and a second wheel, a first halfshaft that connects the first wheel to the differential, and a second halfshaft that connects the second wheel to the differential;
a plurality of sensor devices;
a memory; and
one or more processors configured to perform operations comprising:
receiving sensor data from the plurality of sensor devices;
calculating a wheel rotation delta between the first wheel and the second wheel;
determining a total torque value of at least the first halfshaft based on the wheel rotation delta;
accessing a lookup table to determine a threshold value that corresponds with the first halfshaft based on the sensor data, the lookup table correlating the threshold value with the sensor data;
performing a comparison of the total torque value of the first halfshaft with the threshold value; and
causing display of a visual representation of the comparison.

10. The system of claim 9, wherein the determining the total torque value is based on the wheel rotation delta and a halfshaft stiffness value associated with the first halfshaft.

11. The system of claim 9, further comprising:
issuing an alert based on the comparison.

12. The system of claim 9, further comprising:
applying a torque limit to a drive unit associated with the first halfshaft based on the comparison of the total torque value with the threshold value.

13. The system of claim 9, wherein the sensor data includes one or more of the list comprising:
wheel speed data;
ride height sensor data;
steering angle sensor data; and
torque estimator data that indicate a torque output of a drive unit.

14. The system of claim 9, wherein the accessing the lookup table to determine the threshold value includes:
determining a Constant Velocity (CV) joint angle associated with a CV joint of the first halfshaft based on the sensor data; and
wherein the lookup table correlates the CV joint angle with the threshold.

15. The system of claim 9, wherein the visual representation of the comparison includes a torque capacity indicator that comprises a bar element, wherein the bar element comprises a first graphical attribute based on the threshold value and a second graphical attribute based on the total torque value.

16. The system of claim 9, wherein the visual representation of the comparison includes a graphical representation of a vehicle that comprises an indication of the comparison of the total torque value of the first halfshaft with the threshold value at a position upon the graphical representation of the vehicle that corresponds with the first wheel.

17. A non-transitory machine-readable storage medium, comprising instructions that when executed by one or more processors of a machine, cause the machine to perform operations to visualize torque distribution in a vehicle comprising:
receiving sensor data from a plurality of sensor devices mounted to the vehicle;
calculating a wheel rotation delta between a first wheel and a second wheel of an axle based on the sensor data, the axle comprising a differential, a first halfshaft that connects the first wheel to the differential, and a second halfshaft that connects the second wheel to the differential;
determining a total torque value of at least the first halfshaft based on the wheel rotation delta;
accessing a lookup table to determine a threshold value that corresponds with the first halfshaft based on the sensor data, the lookup table correlating the threshold value with the sensor data;
performing a comparison of the total torque value of the first halfshaft with the threshold value; and
causing display of a visual representation of the comparison.

18. The non-transitory machine-readable storage medium of claim 17, wherein the determining the total torque value is based on the wheel rotation delta and a halfshaft stiffness value associated with the first halfshaft.

19. The non-transitory machine-readable storage medium of claim 17, further comprising:
issuing an alert based on the comparison.

20. The non-transitory machine-readable storage medium of claim 17, further comprising:
applying a torque limit to a drive unit associated with the first halfshaft based on the comparison of the total torque value with the threshold value.
